(19) United States
(12) Patent Application Publication
(10) Pub. No.: US 2010/0252394 A1
(43) Pub. Date: Oct. 7, 2010

(54) Currency Validator and Method of Updating Data Stored in Cash Transacting Machine's Control Via Input Through Currency Validator

(75) Inventors: William C. Stevenson, Chatsworth, CA (US); Steven V. Chesney, Lake Carroll, IL (US)

Correspondence Address: REINHART BOERNER VAN DEUREN P.C., 2215 PERRYGREEN WAY, ROCKFORD, IL, 61107, US

(73) Assignee: Seaga Manufacturing, Inc., Freeport, IL (US)

(21) Appl. No.: 12/418,286

(22) Filed: Apr. 3, 2009

(51) Int. Cl. G07D 7/00; G06F 17/00; G06F 9/44

(52) U.S. Cl. 194/302; 700/231; 717/168

(57) ABSTRACT

A currency validator is adapted to read and transfer data on a data card to an external machine such as a vending machine. The data card includes data for updating programs and operational data stored in a controller of the external machine.

### FIELD OF THE INVENTION

This invention generally relates to an improved currency validator, more particularly an improved currency validator used to input program or other data to a vending machine or other external controller.

### BACKGROUND OF THE INVENTION

Automated currency validators (also commonly called bill or banknote acceptors) are common mechanisms used to authenticate currency or bank notes as they are presented to change making, entertainment, gaming and vending machines, automated bank tellers, ticket kiosks and other ubiquitous machinery. As such, these valuable security mechanisms prevent fraud, counterfeiting, theft and other illegal or illegitimate transactions, while providing a means of accepting cash payment for goods or services by both attended and unattended machinery.

Typically, a currency validator is installed in a machine which operates in exchange of currency or credit, for example, a vending machine, gaming machine, etc. A typical currency validator includes a scanning device and an electronic control system to scan and verify a currency by comparing the currency's image or hidden elements to a known good image or other validating information that only a genuine currency possesses. Once verified that the presented currency is genuine and of a specific valuation, the currency validator will sequester the authenticated currency for later collection by a service person, and will send a signal to communicate the currency's value to the machine, wherein the currency validator is installed. The signal from the currency validator then triggers a control system of the machine to cause a transaction, such as bill payment, change making, and vending of a product.

Among the earliest patents issued for a currency validator, U.S. Pat. No. 2,950,799 dates to 1960 and points out the difficulties of identifying genuine paper currency. With the passage of time, improvements in various technologies for photocopying, complex engraving and printing have made the act of counterfeiting a very sophisticated practice. This has required nations and currency issuing central banks to distribute currencies having improved security features ranging from magnetic inks and specialty papers containing watermarks, to electro-optically reactive images and other unique characteristics that make counterfeiting as difficult as possible. This continual war between technologies and criminals causes a need to constantly update the database or programming of associated currency validator and machine controls.

Improvements in currency validators also include magnetic ink reading capability, as taught by Berube for example in U.S. Pat. No. 3,509,535. Various bar-code reading capabilities such as are taught by Izawa in U.S. Pat. No. 5,420,406 and by Haggerty in U.S. Pat. No. 6,044,952 have also been incorporated in modern currency validators. Presently, the Mars Electronics Incorporated Series 2000 Combo Acceptor even possesses credit & debit card and contactless credit payment options.

Both magnetic striped cards and bar-code printed surfaces are familiar sights everywhere. Magnetic strips on plastic cards are common information carriers for everything from motel keycards and credit cards to paper parking lot tickets.

With the advent of sophisticated computer controls and various sensor technologies, currency validators may possess a self-contained means of verifying currencies of many different issuance cycles and denominations, and are adaptable to future currencies through both data and program updating. As a means of updating the internal program data, Fujita teaches in U.S. Pat. No. 6,993,758 a method of using the scanner portion of the validator as an input means via first a command card that changes the control mode to one that accepts new programming. Fujita in '758 then teaches input of a second information card containing the updated data or programming that adds to or replaces existing validator data or programming.

Machinery that is associated with modern currency validators also contains a sophisticated control circuitry that communicates with the validator, to receive and use the operational output signals regarding authenticity and value of the currency or credit transmitted by the validator. Updating of such remote machine control programming or data presently requires inputting the updated information via many means including card readers, wired and wireless communications protocols and other means. Therefore, the machine, such as a vending machine including a currency validator, typically includes a device (independent of the currency validator) dedicated for data input.

The present invention pertains to improvements in currency validators and method of inputting and communicating data including program updates to an external machine control circuitry of a machine associated with the currency validator.

### BRIEF SUMMARY OF THE INVENTION

One inventive aspect pertains to a currency validator for updating data stored in an external machine controller. The currency validator includes a scanner adapted to read data on a currency and a data card, wherein the data card includes a data for updating a program or an operational data stored in a controller of at least one external machine. The currency validator also includes a control system and a data transfer device, wherein the control system receives the data from the scanner, and validates and processes the currency. The data transfer device transfers the data read from the data card to the at least one external machine.

In another aspect, the invention provides a method of updating a programming data and an operational data of a machine using a currency validator. The method includes steps of providing a currency validator having a data transfer connection to an external machine; receiving a readable object by the currency validator; determining a category of the readable object by the currency validator, the category including a currency and a data card; reading data on the data card using a scanner of the currency validator; toggling an operation mode of the currency validator by a validator controller from a validation mode to a program mode when a program command is detected by the validator controller; transferring the data read from the data card to the external machine by the currency validator; processing the data by a machine controller of the external machine; and updating the programming data and operational data by the machine controller.

The present invention also provides a vending machine including a tray, a controller, a currency validator and a data transfer connection between the controller and the currency validator. The tray holds vendable products and the controller controls operation of the vending machine, wherein the currency validator is adapted to communicate a data for updating a program and an operational data stored in the controller.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 illustrates a currency validator and a data input media according to an embodiment of the present invention;

FIG. 2 illustrates a detailed view of a data input media according to an embodiment of the present invention;

FIG. 3 is a perspective view of a vending machine including a currency validator according to an embodiment of the present invention; and

FIG. 4 is a perspective view of an addressable information display of the vending machine of FIG. 3.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

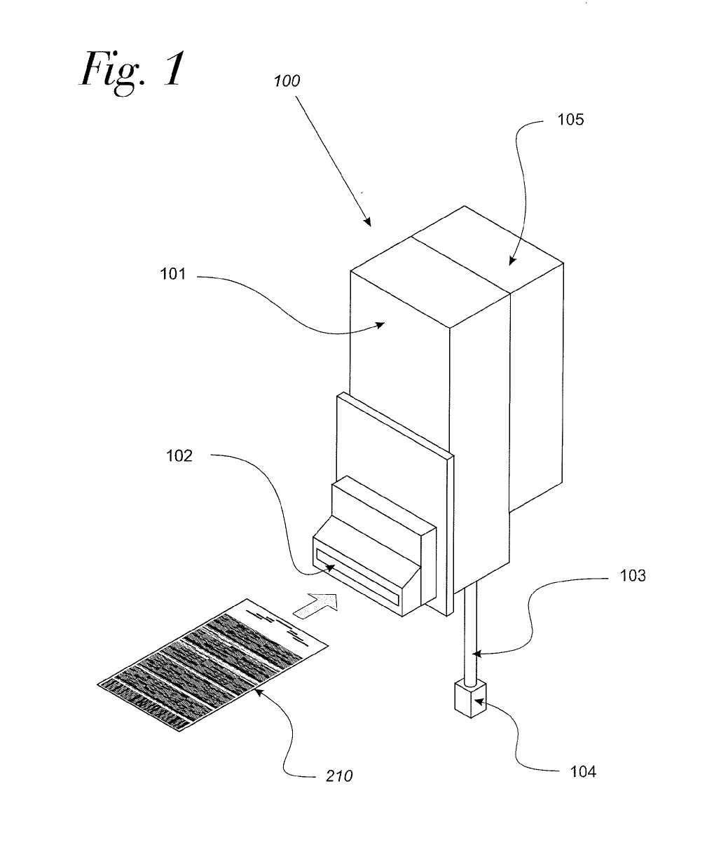

FIG. 1 is an illustration of a currency validator 100 and a data input media 210 according to an embodiment of the present invention. The currency validator 100 includes an electronics module 101, an input slot 102, a power cable 103 having a connector 104, and a storage module 105. The electronic module includes an onboard electronic control circuitry and scanner mechanism(s) (not shown) necessary to perform currency validation and a data card processing. The input slot 102 accepts a currency and/or a data card such as the data input media 210 inputted by a user. The power cable 103 and the connector 104 are used to interfacially connect the currency validator 100 to control circuitry of an external machine such as a vending machine via industry standard communication bus and language. The storage module 105 is configured to store currency for later retrieval by a service person. The scanning mechanisms may include optical and electromagnetic sensing capability interfaced with an electronic control circuitry capable of converting read signals to digital output for further processing by the onboard electronic control, or communication to externally connected machine controls. The data input media 210 contains data elements readable by the scanner mechanism. The data elements read by the scanning mechanism may be stored as raw scanned data and transferred to an external machine control system, such as a control system of a vending machine employing the currency validator 100, or converted onboard to an industry standard machine language before transferring to the external machine control system, or processed to update information of the onboard control circuitry contained within electronics module 101.

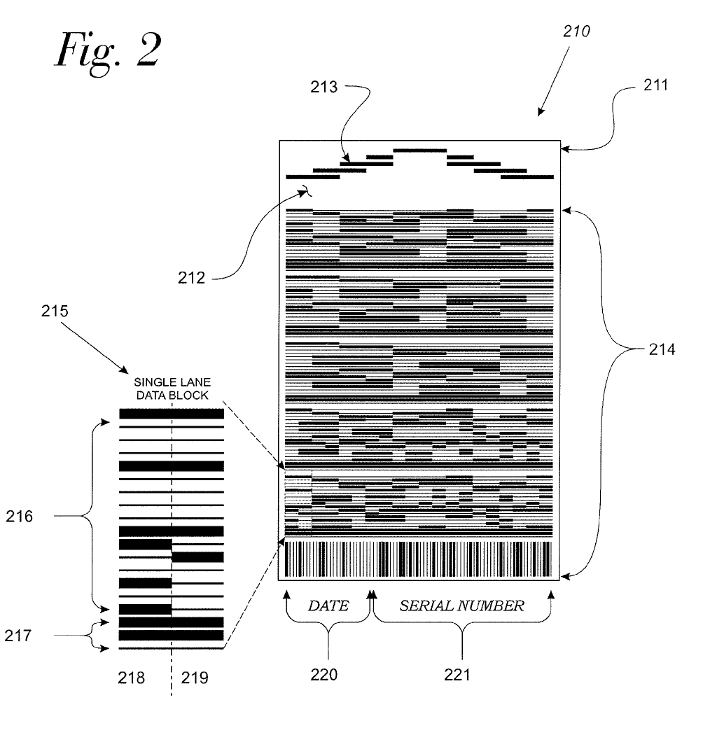

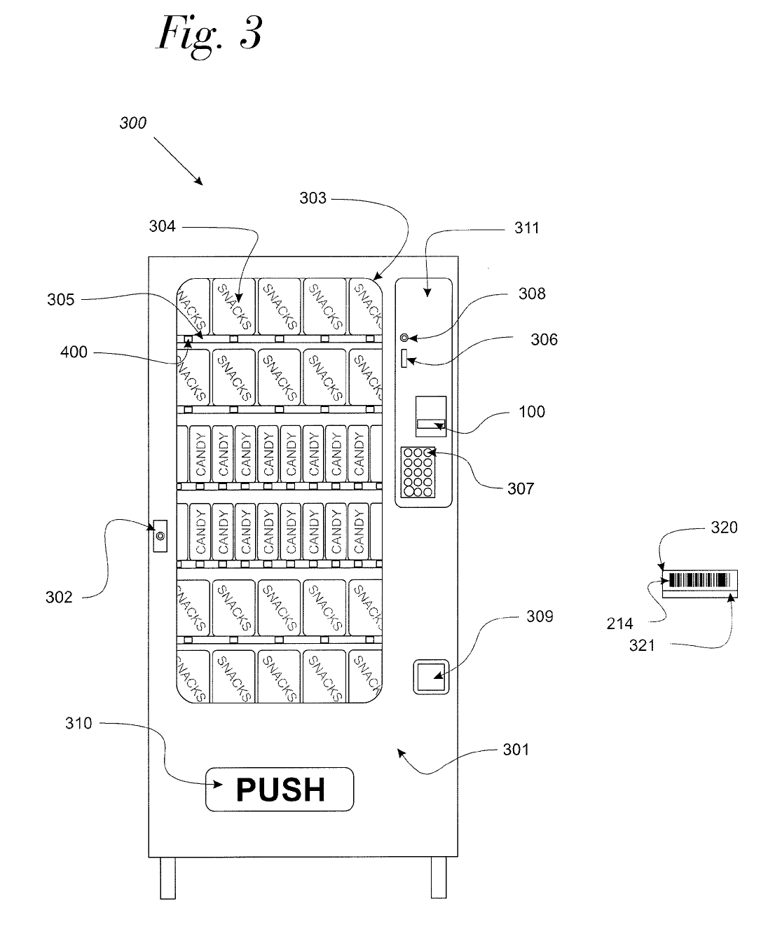

As the data input media 210 is inserted through the input slot 102 to an interior scanner of the electronics module 101, the scanner reads data contained within the data media 210. In one embodiment, the data includes a security element 212 to verify the validity of the data to be inputted, and program update data 214 as shown in FIG. 2. In an alternate embodiment, data input media 210 may be supplemented by data input media 320 as shown in FIG. 3, wherein data input media 320 possesses both optical data 214 and magnetic data 321, the data readable by an interior scanner of the electronics module 101. If the data input media 210 or 320 is verified as genuine, the data 214 or 320 is then accepted by onboard control circuitry contained within electronics module 101 and used to update the internal control programming or other data of the currency validator 100, or alternately communicated to an external machine controller for updating the external machine controller's programming or database. In a preferred embodiment, the currency validator 100 is installed in a vending machine, and the data input media 210 or 320 includes data for updating various programs of the vending machine or for updating product information data such as pricing on a vending machine's information display.

To ensure that only a genuine data input media 210 is used, the security element 212 causes the onboard control circuitry to toggle from an “operating” condition to a “program” or alternately to a “remote program” mode, wherein the data 214 is used to update the onboard or external machine control memory. When in the “remote program” mode, the data 214 is scanned and communicated to a connected external machine control via the cable 103 and connector 104 interface. In other embodiments, the data 214 may be communicated to the external machine control via wireless means. Further, the currency validator 100 may be configured to communicate with multiple external machines. For example, the currency validator 100 may include a transceiver to communicate pricing or programming updates to multiple washers and dryers. In such embodiment, the currency validator 100 can be installed in a currency to coin change machine securely attached to a laundromat's wall, wherein the currency validator 100 transmits data to washers and dryers located throughout the laundromat.

In another embodiment, the currency validator 100 having a wireless communications mode can be used to transmit various data to multiple vending machines. In such embodiment, the currency validator 100 can provide a remote payment capability for at least one slaved vending machine. Further, the currency validator 100 installed in a vending machine can transmit product information data to other remote vending machines. Upon completion of the verification and data 214 uploading steps, the data input media 210 may then be taken into the currency storage module 105 for safekeeping and later retrieval, or returned to the service technician for use in other improved currency validators.

In one embodiment, inserting data media 210 into slot 102 causes the electronic module's 101 onboard electronic control to perform steps of first reading and validating the data; second, toggling operation mode to program mode; third, storing the new data within onboard memory and erasing old stored data; fourth, toggling the electronic control from program mode to operating mode then lastly disposing of the data media 210 by either storage within the storage module 105, or ejecting it out through the slot 102. An alternate third step includes temporarily storing scanned data for transmission to an at least one external machine control, such as a vending machine control via cable 103 and connector 104. In this alternate third step, the scanned data may be further processed by the onboard electronic control to translate the scanned data to specific communication language protocols before transmission to the external machine control. Additionally, when transmission of data is completed to the external machine control, the electronic module's 101 onboard temporary memory may then be erased. Alternatively, the electronic module may wait for the external machine control to return a confirmation signal of successful data transfer before erasing data on the onboard temporary memory. In absence of the confirmation signal, data transmission to the external machine control may repeat until a confirmation signal is received by the currency validator 100 onboard electronic controls.

If either the data input media 210 or data 214 is declared false, the scanner mechanism of electronics module 101 aborts the programming process and physically ejects data input media 210 through the slot 102, and the onboard control circuitry memory remains unchanged and in “operating” mode.

FIG. 2 illustrates a preferred data media 210 as a printable card 211 that possesses various programming and security features and optically readable data elements broken into a first scannable authentication feature 212 that is invisible to the human eye, a program mode command 213 data shown here as a visible image of multiple horizontal bars arranged into a pattern, and data 214 for updating the currency validator's 100 onboard electronic control memory or that of an external machine, according to an embodiment of the present invention.

The data 214 is illustrated as further divided into various elements, for example first illustrated herein as rows of visible horizontal barcode block elements 215, each having both specific update data 216 and a data block “end” command 217. The update data 216 is also further shown in detail as dual barcode columns labeled 218 and 219, thus illustrating a method of data storage that is compact and thus conserves data recording space on the card 211. In one embodiment, the dual column data blocks 218 and 219 represent a single unit retail price of a vended good and alternate multiple sale discount pricing. Similarly, the dual pricing may be applied to time related vending of goods at different supply vs. demand pricing levels to anticipate differing degrees of traffic throughout a day. In a different embodiment, the dual pricing levels may be applied to a venue by updating pricing for high and low traffic days, thus encouraging customers to use the facilities on low traffic days and homogenizing the cash-flow of a laundromat or coin operated car wash business.

The data 214, as shown in FIG. 2, has a row of vertical barcode elements divided into date 220 data and serial number 221 data usable for confirmation of aforesaid authentication process. In arranging the data 214 into a multitude of columnar data blocks and rows of data blocks to form a matrix, a layout of a vending machine's product display may also be duplicated for use on a computer screen display useful for programming individual product pricing via a cut-and-paste process of lifting data block 215 images from a library of the same stored within a vending route operator's computer memory.

Therefore, the data 214 is usable to update both program or data information of the memory of the onboard electronic controls of the electronic module 101. Further, the data 214 can be used to input information or update program of the at least one external machine.

FIG. 3 illustrates a vending machine 300 including a currency validator 100 according to an embodiment of the present invention. The vending machine 300 includes a secure enclosure cabinet 301 and having a lockable access 302. The vending machine 300 stores vendable products 304 for sale and displays them on trays 305 having addressable product information displays 400, which are viewable behind a window 303. The vending machine 300 has a control panel 311 where a customer can make a payment via the currency validator 100 or via a coin slot 306 before inputting order selection code via keypad 307. As discussed above with regards to the currency validator 100 (FIG. 1), the currency validator is equipped with a scanner and a control system to scan and validate a bill inputted by the customer. Once the currency validator determines the authenticity and a value of the bill, the currency validator 100 transmits the information to a control system (not shown) of the vending machine 300. The control system of the vending machine 300 then calculates a change to be given based on the information received from the currency validator 100, and triggers the vending machine 300 to deliver the selected product 304 to a delivery area located behind a pickup access door 310. The calculated amount of the change is delivered in a coin return cup 309. Pressing a coin return button 308 cancels a credit, and returns all unused cash to coin return cup 309.

As discussed above, the currency validator 100 can be configured to read a data media 210, 320 (FIGS. 1-3). In one embodiment, the currency validator 100 includes a scanner configured to read data on the data media 210 to update various information of the control system of the vending machine 300. In an alternate embodiment, data input media 210 may be supplanted by data input media 320 as shown in FIG. 3 wherein data input media 320 possesses both optical data 214 and magnetic data 321, said data readable by an interior scanner of the electronics module 101. The data media 210, 320 may include data to update various control programs of the vending machine's control system and/or to update information on the addressable product information display 400.

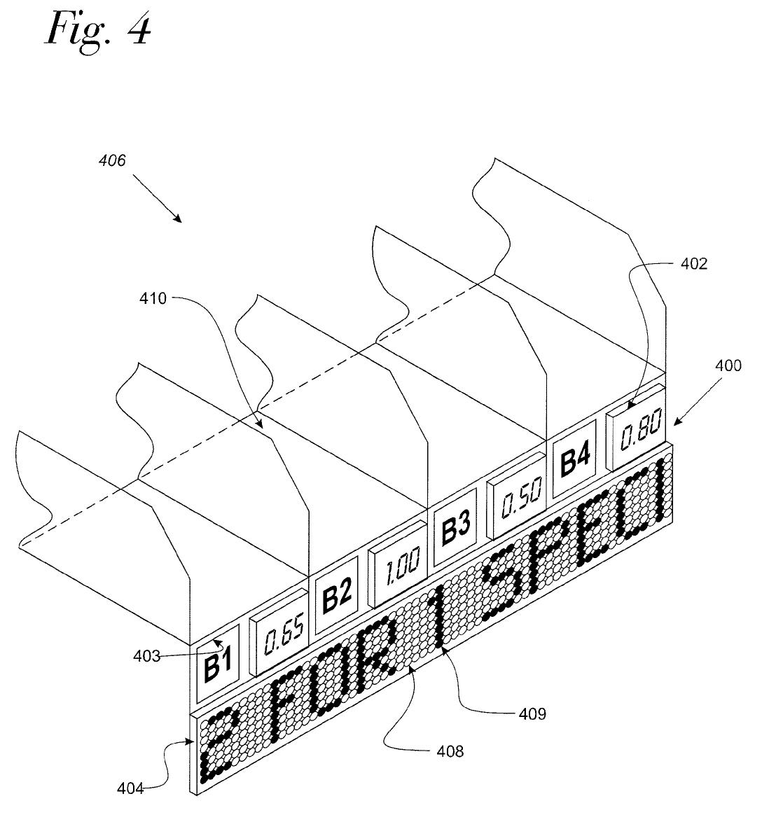

The addressable product information display 400 according to one embodiment of the present invention is shown in FIG. 4. The addressable product information display 400 includes a price information module 402 and a secondary information module 404. As shown, the addressable product information display 400 is attached to a horizontal support plane 410 of a vending machine product holding tray 406. The price information module 402 is positioned adjacent to a lane identification label 403 to display a price for the product stored in the corresponding lane. The secondary information module 404 is displayed under the price information module 402 and the lane identification labels 403. The secondary information module 404 can include a matrix display of light emitting diodes 408 that displays illuminated information 409 for presentation of various product information, such as a special sale deal information or a product specific marketing advertisement.

In this embodiment, the data media 210 including product pricing information and product advertisement information is inserted into the currency validator 100, wherein the scanner located in the electronics module 101 (FIG. 1) reads data on the data media 210. The control system of the currency validator 100 converts the scanned data into a vending machine industry standard language and communication protocols and transmits the information via an associated standard bus or network format to the vending machine 300. (For example, DEX communication protocol and MDB communication bus.) In a different embodiment, the currency validator 100 may transmit the scanned date in its raw format (that is unconverted) to the vending machine 300 to be converted and processed by the vending machine control system.

The transmitted data from the currency validator 100 is received and processed in the vending machine control system, which triggers an update process of the addressable product information display 400. Further, the data media 210 can also include data to update other vending machine operational information. For example, the data media 210 may include cooling control information to adjust temperature according to stored products, or lighting control information to periodically adjust display lighting, etc.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A currency validator for updating data stored in an external machine controller, comprising:
a scanner adapted to read data on a currency and a data card, the data card including data for updating a program or an operational data stored in a controller of at least one external machine;
a control system receiving the data from the scanner, and validating and processing the currency; and
a data transfer device transferring the data read from the data card to the at least one external machine.

2. The currency validator of claim 1, wherein the at least one external machine includes a vending machine, wherein the scanner reads the data card including the data for updating a program or operational data stored in a vending machine controller; wherein the data transfer device transfers the data from the data card to the vending machine controller.

3. The currency validator of claim 2, wherein the data is received by the vending machine controller, wherein the data includes product pricing information for addressable information displays in the vending machine, the vending machine controller processing the data and updating the product pricing information on the addressable information displays.

4. The currency validator of claim 2, wherein the control system receives the scanned data from the data card and converts the data into a vending machine industry standard language and transfers the converted data to the vending machine via a vending machine industry standard interface between the vending machine and the currency validator.

5. The currency validator of claim 4, wherein the vending machine industry standard language and interface are DEX and MDB.

6. The currency validator of claim 1, further including a data transfer connection between the currency validator and the at least one external machine.

7. The currency validator of claim 6, wherein the data transfer connection is a hardwire connection.

8. The currency validator of claim 6, wherein the data transfer connection is a wireless communication.

9. The currency validator of claim 1, wherein the at least one external machine includes a host vending machine, wherein the currency validator is installed, and multiple remote vending machines, the currency validator processing payments for the host vending machine and the multiple remote vending machines, and transferring the data for updating a program or an operational data stored in controllers of the host vending machine and the multiple remote vending machines.

10. The currency validator of claim 1, wherein the at least one external machine includes at least one coin operated clothes washer or dryer.

11. The currency validator of claim 1, wherein the at least one external machine includes at least one coin operated car washing system.

12. The currency validator of claim 1, wherein the at least one external machine includes at least one gaming machine.

13. The currency validator of claim 1, wherein the at least one external machine includes a juke box, a pinball machine, a video game, or an amusement machine.

14. The currency validator of claim 1, wherein the at least one external machine includes an internet machine, a telephone, a facsimile machine, or a copying and printing machine.

15. The currency validator of claim 1, wherein the data card includes an invisible security data and a visible data, wherein the scanner is adapted to read both the invisible and visible data.

16. A method of updating a programming data and an operational data of a machine using a currency validator, comprising steps of:
providing a currency validator having a data transfer connection to an external machine;
receiving a readable object by the currency validator;
determining a category of the readable object by the currency validator, the category including a currency and a data card;
reading data on the data card using a scanner of the currency validator;
toggling an operation mode of the currency validator by a validator controller from a validation mode to a program mode when a program command is detected by the validator controller;
transferring the data read from the data card to the external machine by the currency validator;
processing the data by a machine controller of the external machine; and
updating the programming data and operational data by the machine controller.

17. The method of claim 16, further including converting of the data read by the scanner by the validator controller prior to transferring the data to the external machine.

18. The method of claim 16, wherein the data read by the scanner is transferred to the external machine in a raw scanned data format, wherein the data conversion process is performed by the machine controller of the external machine.

19. A vending machine, comprising:
a product holding means to securely store vendable products;
a controller controlling operation of the vending machine;
a currency validator adapted to communicate data for updating a program and an operational data stored in the controller; and
a data transfer connection between the controller and the currency validator.

20. The vending machine of claim 19, wherein the currency validator includes:
a scanner adapted to read data on a currency and a data card, the data card including the data for updating the program and the operational data stored in the controller;
a validator controller receiving the data from the scanner, and validating and processing the currency; and
a data transfer device transferring the data read from the data card to the controller of the vending machine.

21. The vending machine of claim 20, further including an addressable product information display attached to the product storage means, the addressable product information display displaying pricing and other product advertisement information of the vendable products on the storage means; the data card including pricing and other product advertisement information update data, wherein the controller receives the data from the currency validator and updates the information displayed on the addressable product information display.
